(19) United States
(12) Patent Application Publication
(10) Pub. No.: US 2018/0334582 A1
(43) Pub. Date: Nov. 22, 2018

(54) ACRYLIC POLYMERS FOR INKJET INK APPLICATIONS

(71) Applicant: Cabot Corporation, Boston, MA (US)

(72) Inventors: Tianqi Liu, Boxborough, MA (US); Jinqi Xu, Westford, MA (US)

(21) Appl. No.: 15/971,047

(22) Filed: May 4, 2018

Related U.S. Application Data
(60) Provisional application No. 62/508,207, filed on May 18, 2017.

(51) Int. Cl. C09D 11/322; C09D 11/38; C09D 11/107; C08K 5/5333

(52) U.S. Cl. CPC C09D 11/322; C09D 11/38; C08F 20/18; C08K 5/5333; C09D 11/107

(57) ABSTRACT

Disclosed herein are inkjet ink compositions comprising: at least one pigment having attached at least one organic group having a calcium index value greater than a calcium index value of 1,2,3-benzene tricarboxylic acid; at least one acrylic polymer having an acid number of at least 150 and a weight average molecular weight ranging from 1,000 to 15,000; and an aqueous liquid medium.

### FIELD OF THE INVENTION

Disclosed herein are inkjet ink compositions comprising at least one pigment and at least one acrylic polymer.

### BACKGROUND

There is a need for pigment-based inkjet ink compositions having suitable optical density, e.g., when deposited on plain paper.

### SUMMARY

Disclosed herein are inkjet ink compositions comprising:

at least one pigment having attached at least one organic group having a calcium index value greater than a calcium index value of 1,2,3-benzene tricarboxylic acid;

at least one acrylic polymer having an acid number of at least 150 and a weight average molecular weight ranging from 1,000 to 15,000; and

an aqueous liquid medium.

### DETAILED DESCRIPTION

For aqueous inkjet printing on plain papers, because of the hydrophilic nature and high porosity of the substrates, it is common to see pigment particles penetrating the paper fiber network. This can result in low optical density (OD) on the top surface of the paper and/or high see-through on the back side. For inkjet applications, some grades of plain papers are treated with free soluble di/trivalent ions, e.g., calcium and/or magnesium. The di/trivalent metal ions coagulate with the pigments to form larger aggregates. As a result, pigment penetration into the fiber is reduced and higher pigment concentration remains on the top surface. However, this paper treatment can add cost to the paper manufacturers, printing facilities, and eventually the consumers.

Another desirable attribute for aqueous inkjet printing is quick drying of the ink droplets on the paper to avoid smear and image transfer. However, ink formulation approaches to enable faster drying (e.g., enabling the inkjet liquid to penetrate faster into the paper fiber network) result in low optical density due to the insufficient amount of time for pigments to interact with paper fiber or calcium carbonate.

It was discovered that certain polymer and pigment combinations can enhance at least optical density by inkjet printing on plain paper. Accordingly, one embodiment provides an inkjet ink composition comprising:

at least one pigment having attached at least one organic group having a calcium index value greater than a calcium index value of 1,2,3-benzene tricarboxylic acid;

at least one acrylic polymer having an acid number of at least 150 KOH/g and a weight average molecular weight ranging from 1,000 to 15,000; and

an aqueous liquid medium.

In one embodiment, the at least one polymer is an acrylic polymer. In one embodiment, the acrylic polymer comprises at least one acrylic monomer. In one embodiment, the at least one acrylic monomer comprises an ethylenically unsaturated carboxylic acid and salts thereof.

In one embodiment, the at least one acrylic monomer is characterized by its acid number (AN). The acid number of the at least one acrylic polymer can be calculated from the following equation:

AN=(no. mol of COOH-containing monomer×56.1 mgKOH×1000)/(the total mass (g) of monomers

In one embodiment, the COOH-containing monomer can comprise the acrylic monomer and optionally other monomers containing COOH. In another embodiment, the COOH-containing monomer is the acrylic monomer. In one embodiment, the acrylic polymer has an acid number of at least 150 KOH/g (acrylic polymer). In another embodiment, the acid number is at least 160 KOH/g acrylic polymer, at least 175, or at least 200. In another embodiment, the acid number ranges from 150 to 400, e.g., from 160 to 400, from 175 to 500, from 200 to 400, from 150 to 300, from 160 to 300, from 175 to 300, or from 200 to 300 KOH/g acrylic polymer.

In one embodiment, the at least one acrylic polymer has a weight average molecular weight ranging from 1,000 to 15,000, e.g., from 1,000 to 14,000, or from 1,000 to 13,000.

In plain paper manufacturing, starch is added to the base sheet as a glue to bind inorganic particles together and impart stiffness of the sheets for runnability in printing presses. Starch is sensitive to water and can swell dramatically upon contact with water. Without wishing to be bound by any theory, certain polymers in aqueous ink compositions may facilitate the process of starch wetting and swelling to afford improved OD performance. The swelled starch can lower the porosity of the plain paper and therefore hinder the penetration of pigment particles into the paper fiber network.

Without wishing to be bound by any theory, polymers having a low molecular weight and high acid number (contributing to hydrophilicity) are relatively mobile and can facilitate wetting and swelling of the starch in/on the plain paper surface. The resulting reduction in paper porosity may enable more efficient capture of the pigment particles by the paper fiber matrix, e.g., for plain paper, or di/trivalent metal ions present in a treated paper. This allows the pigment particles to remain on the top surface of the paper and maximize pigment use in contributing to optical density performance.

In one embodiment, the at least one acrylic polymer comprises at least one acrylic monomer in an amount of at least 20 mol %, e.g., an amount of at least 25 mol %. The at least one acrylic polymer can be a copolymer. In another embodiment, the at least one acrylic polymer comprises at least one acrylic monomer in an amount ranging from 20 mol % to 75 mol %, e.g., from 25 mol % to 75 mol %, from 20 mol % to 70 mol %, from 25 mol % to 70 mol %, from 20 mol % to 65 mol %, or from 25 mol % to 65 mol %.

In one embodiment, the at least one acrylic monomer is selected from acrylic acid, methacrylic acid, crotonic acid, ethacrylic acid, propylacrylic acid, isopropylacrylic acid, itaconic acid, and fumaric acid, and salts thereof. In one embodiment, the at least one acrylic monomer is selected from acrylic acid, methacrylic acid, and salts thereof.

In one embodiment, the at least one acrylic polymer is a copolymer. In addition to the at least one acrylic monomer, the at least one acrylic polymer can further comprise at least one second monomer that is copolymerizable with the at least one acrylic monomer. In one embodiment, the at least one second monomer is selected from: esters, aminoesters and amides of acrylic acid, methacrylic acid, crotonic acid, ethacrylic acid, propylacrylic acid, isopropylacrylic acid, itaconic acid, fumaric acid, and maleic acid; addition reaction products between oil and fatty acids and (meth)acrylic ester monomers having an oxirane structure; addition reaction products between oxirane compounds containing an alkyl group having 3 or more carbon atoms and (meth)acrylic acid; styrenes; acrylonitriles; acetates; and allyl alcohols. In one embodiment, the at least one second monomer is selected from styrenes.

Exemplary second monomers include (meth)acrylic esters, such as methyl acrylate, ethyl acrylate, isopropyl acrylate, n-propyl acrylate, n-butyl acrylate, t-butyl acrylate, 2-ethylhexyl acrylate, n-octyl acrylate, lauryl acrylate, benzyl acrylate, methyl methacrylate, ethyl methacrylate, isopropyl methacrylate, n-propyl methacrylate, n-butyl methacrylate, isobutyl methacrylate, t-butyl methacrylate, 2-ethylhexyl methacrylate, n-octyl methacrylate, lauryl methacrylate, stearyl methacrylate, tridecyl methacrylate, and benzyl methacrylate; addition reaction products between oil and fatty acids and (meth)acrylic ester monomers having an oxirane structure, such as an addition reaction product between stearic acid and glycidyl methacrylate; addition reaction products between oxirane compounds containing an alkyl group having 3 or more carbon atoms and (meth)acrylic acid; styrenes, such as styrene, α-methylstyrene, o-methylstyrene, m-methylstyrene, p-methylstyrene, and p-tert-butylstyrene; itaconic esters, such as benzyl itaconate; maleic esters, such as dimethyl maleate; fumaric esters, such as dimethyl fumarate; and acrylonitrile, methacrylonitrile, vinyl acetate, isobornyl acrylate, isobornyl methacrylate, aminoethyl acrylate, aminopropyl acrylate, methylaminoethyl acrylate, methylaminopropyl acrylate, ethylaminoethyl acrylate, ethylaminopropyl acrylate, aminoethylamide of acrylic acid, aminopropylamide of acrylic acid, methylaminoethylamide of acrylic acid, methylaminopropylamide of acrylic acid, ethylaminoethylamide of acrylic acid, ethylaminopropylamide of acrylic acid, methacrylic acid amide, aminoethyl methacrylate, aminopropyl methacrylate, methylaminoethyl methacrylate, methylaminopropyl methacrylate, ethylaminoethyl methacrylate, ethylaminopropyl methacrylate, aminoethylamide of methacrylic acid, aminopropylamide of methacrylic acid, methylaminoethylamide of methacrylic acid, methylaminopropylamide of methacrylic acid, ethylaminoethylamide of methacrylic acid, ethylaminopropylamide of methacrylic acid, hydroxymethyl acrylate, 2-hydroxyethyl acrylate, 2-hydroxypropyl acrylate, hydroxymethyl methacrylate, 2-hydroxyethyl methacrylate, 2-hydroxypropyl methacrylate, N-methylolacrylamide, and allyl alcohol.

In one embodiment, the at least one acrylic polymer is self-dispersible or soluble in an aqueous liquid medium, e.g., does not need additional surfactants or dispersants to disperse or dissolve in the aqueous liquid medium. In one embodiment, the at least one acrylic polymer is a salt of at least one of an alkali metal and an organic amine. In one embodiment, the salt is generated from reaction of carboxylic acid-containing groups of the polymer with one or more of an organic amine, an alkali metal, and a base. Examples of a salt of the at least one acrylic polymer with an alkali metal includes a salt of lithium, sodium, or potassium. Such salts can be prepared, e.g., from a reaction with lithium hydroxide, sodium hydroxide, or potassium hydroxide. Examples of a salt of the at least one acrylic polymer with an organic amine include salts of ammonia, triethylamine, tributylamine, dimethylethanolamine, diisopropanolamine, and morpholine, diethanolamine, and triethanolamine.

In one embodiment, the at least one acrylic polymer is present in an amount ranging from 0.5 wt % to 5 wt % relative to the total weight of the composition, e.g., an amount ranging from 0.5 wt % to 4 wt %, from 0.5 wt % to 3 wt %, from 1 wt % to 5 wt %, from 1 wt % to 4 wt %, or from 1 wt % to 3 wt %.

In one embodiment, the polymer/pigment ratio is 0.05 to 2, e.g., from 0.05 to 1, from 0.05 to 0.5, from 0.1 to 2, from 0.1 to 1, from 0.1 to 0.5, from 0.15 to 2, from 0.15 to 1, or from 0.15 to 0.5.

In one embodiment, the pigment is a self-dispersed pigment, e.g., the pigment is self-dispersible. In one embodiment, the self-dispersed pigment is a modified pigment having at least one attached organic group. In one embodiment, an “attached” organic group can be distinguished from an adsorbed group in that a soxhlet extraction for several hours (e.g., at least 4, 6, 8, 12, or 24 hours) will not remove the attached group from the pigment. In another embodiment, the organic group is attached to the pigment if the organic group cannot be removed after repeated washing (e.g., 2, 3, 4, 5, or more washings) with a solvent or solvent mixture that can dissolve the starting organic treating material but cannot disperse the treated pigment. In yet another embodiment, “attached” refers to a bond such as a covalent bond, e.g., a pigment bonded or covalently bonded to the organic group.

In one embodiment, the composition comprises at least one pigment having attached at least one organic group capable of binding calcium, i.e., having a calcium index value greater than a calcium index value of 1,2,3-benzene tricarboxylic acid. In one embodiment, calcium binding capability can be quantified via calcium index values, as described in U.S. Pat. No. 8,858,695, the disclosure of which is incorporated herein by reference. “Calcium index value” refers to a measure of the ability of an organic group to coordinate or bind calcium ions in solution. The higher the calcium index value, the more strongly or effectively the group can coordinate calcium ions. Calcium index values can also be used to indicate binding capability of other divalent metal ions, e.g., magnesium.

Calcium index values can be determined by any method known in the art. For example, the calcium index value may be measured with a method in which the amount of calcium coordinated by a compound in a standard solution containing soluble calcium ions and a color indicator is measured using UV-Vis spectroscopy. Alternatively, for compounds having a strong color, the calcium index value may be measured using an NMR method.

In one embodiment, “calcium index value,” is determined according to the methods described in U.S. Pat. No. 8,858,695, e.g., Method A or Method B at col. 29, line 45 to col. 31, line 37, the disclosure of which is incorporated herein by reference. For either method used, a compound was chosen that corresponds to a desired organic group to be tested. In the test compound, the at least one organic group can be bonded to any residue so long as the atoms responsible for binding calcium ions are separated from the residue by at least two bonds. The residue can comprise or consist of hydrogen, a C₁-C₁₀ alkyl (substituted or unsubstituted), or C₄-C₁₈ aryl (substituted or unsubstituted), e.g., the compound to be tested can comprise the organic group bonded to hydrogen, a C₁-C₁₀ alkyl (substituted or unsubstituted), or C₄-C₁₈ aryl (substituted or unsubstituted). For example, for a 3,4,5-tricarboxyphenyl functional group and salts thereof, 1,2,3-benzene tricarboxylic acid can be chosen. In this example, the residue is hydrogen and the oxygen atoms of the carboxylic acids are at least two bonds away from the hydrogen residue.

In one embodiment, reference to the calcium index value means that the value is greater than or equal to that of a reference material. In one embodiment, the reference is 1,2,3-benzene tricarboxylic acid. Thus, the at least one organic group, has a calcium index value that is greater than the calcium index value of 1,2,3-benzene tricarboxylic acid. In another embodiment, the reference is 1,2,3-benzene tricarboxylic acid. In one embodiment, the calcium index value is greater than or equal to 2.8, greater than or equal to 3.0, or greater than or equal to 3.2, as determined using UV-Vis spectroscopy (or method A), as described in more detail below.

Method A. For this method, a series of solutions were prepared at pH 9 that contained 0.087 mM Congo Red indicator, 5 mM cesium chloride, 1 wt % MW350 polyethylene glycol methyl ether, and calcium chloride in concentrations ranging from 0 to 7 mM (0.2, 0.5, 1, 2, 3, 4, 4.5, 5, 6, and 7 mM). The UV-Vis spectra of these solutions were recorded within 1 hour of their preparation using a UV-2501PC. These spectra were used to create a calibration curve relating the absorbance at 520 nm to the calcium concentration.

Test solutions were then prepared at pH 9 that contained 0.087 mM Congo Red indicator, 1 wt % MW350 polyethylene glycol methyl ether, 5 mM calcium chloride, and the cesium salt of the compound of interest such that the ion concentration at pH 9 was 5 mM. The uncomplexed calcium concentration was determined by comparison with the calibration curve. The calcium index value was then calculated as log₁₀((0.005−uncomplexed calcium)/((uncomplexed calcium)²)). Measurements were made in duplicate and averaged.

Method B. For compounds that develop a high level of color and are therefore difficult to use in Method A, a second method was developed. For this method, an aqueous solution that was 0.01M in ⁴³CaCl₂, 0.01M in NaCl, 10% D₂O and at pH 8 or 9 was prepared from ⁴³CaCO₃, HCl/D₂O, NaOH/D₂O, D₂O and water. The pH was chosen to ionize the compound under investigation and to dissolve the compound. A portion of the solution weighing about 0.65 g was added to a 5 mm NMR tube and weighed to the nearest 0.001 g. The chemical shift of the unbound ⁴³Ca was measured using a Bruker Avance II spectrometer with a proton resonance frequency at 400.13 MHz. A 0.2-1.0M solution of the compound (ligand) under investigation was added in successive increments. After each addition, the ⁴³Ca chemical shift was measured, and 6, the difference between the chemical shift of the sample and that of unbound calcium was calculated. The successive increments were planned such that the Lₒ/Caₒ ratio was 0.25, 0.5, 1, 2, 3, 4, 6 and 8 where Lₒ is the total concentration of complexed, protonated and free anions from the ligand and Caₒ is the total concentration of calcium in all species present. The calcium index value (NMR) was calculated as log₁₀(X) where X was determined by fitting the parameters X and δₘ in the equation:

$$δ = \frac{{δ}_{m}}{2} \{ [ 1 + ( {L}_{0} / {Ca}_{0} ) + ( 1 + {H}^{+} / {K}_{a} ) / ( {X Ca}_{0} ) ] - \sqrt{{[ 1 + ( {L}_{0} / {Ca}_{0} ) + ( 1 + {H}^{+} / {K}_{a} ) / ( {X Ca}_{0} ) ]}^{2} - 4 ( {L}_{0} / {Ca}_{0} )} \}$$

so that the RMS difference between the data and the predicted chemical shifts from the equation are minimized where:

δ is the difference in the ⁴³Ca chemical shift of the sample vs that of free aqueous ⁴³Ca²⁺;

δₘ is the calculated difference in the ⁴³Ca chemical shift at infinite L/Ca vs that of free ⁴³Ca²⁺;

Lₒ is the total concentration of complexed, protonated and free anions from the ligand;

Caₒ is the total concentration of calcium in all species present;

X is a fitting parameter; and

Kₐ is the proton dissociation constant for the ligand LH.

In one embodiment, the at least one organic group is selected from at least one phosphonic acid group (e.g., at least two phosphonic acid groups), partial esters thereof, and salts thereof, such as a geminal bisphosphonic acid group, partial esters thereof, and salts thereof. In one embodiment, the at least one organic group may comprise at least one geminal bisphosphonic acid group, partial esters thereof, and salts thereof, that is, the at least one organic group may comprise at least two phosphonic acid groups, partial esters thereof, and salts thereof that are directly bonded to the same carbon atom. Such a group may also be referred to as a 1,1-diphosphonic acid group, partial ester thereof, or salt thereof. Thus, for example, the at least one organic group may comprise a group having the formula —CQ(PO₃H₂)₂, partial esters thereof, and salts thereof. Q is bonded to the geminal position and may be H, R, OR, SR, or NR₂ wherein R, which can be the same or different, is H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For example, Q may be H, R, OR, SR, or NR₂, wherein R, which can be the same or different, is H, a C₁-C₆ alkyl group, or an aryl group. In one embodiment, Q is H, OH, or NH₂. Furthermore, the at least one organic group may comprise a group having the formula —(CH₂)ₙ—CQ(PO₃H₂)₂, partial esters thereof, and salts thereof, wherein Q is as described above and n is 0 to 9, such as 1 to 9, 0 to 3, or 1 to 3. In one embodiment, n is either 0 or 1. Also, the at least one organic group may comprise a group having the formula —Y—(CH₂)ₙ—CQ(PO₃H₂)₂, partial esters thereof, and salts thereof, wherein Q and n are as described above and Y is an arylene, heteroarylene, alkylene, vinylidene, alkarylene, aralkylene, cyclic, or heterocyclic group. In one embodiment, Y is an arylene group, such as a phenylene, naphthalene, or biphenylene group, which may be further substituted with any group, such as one or more alkyl groups or aryl groups. When Y is an alkylene group, examples include, but are not limited to, substituted or unsubstituted alkylene groups, which may be branched or unbranched and can be substituted with one or more groups, such as aromatic groups. Examples include, but are not limited to, C₁-C₁₂ groups like methylene, ethylene, propylene, or butylene, groups.

Y may be further substituted with one or more groups selected from, but not limited to, R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR₂′, wherein R′ which can be the same or different, is independently hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

In one embodiment, the at least one organic group may comprise a group having the formula —Y-Sp-(CH₂)ₙ—CQ(PO₃H₂)₂, partial esters thereof, or salt thereof, wherein Y, Q, and n are as described above. Sp is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different, represents hydrogen or an organic group such as a substituted or unsubstituted aryl or alkyl group. As shown by the structure above, a group comprising at least two phosphonic acid groups and salts thereof is bonded to Y through the spacer group Sp. In one embodiment, Sp is —CO₂—, —O₂C—, —O—, —NR″CO—, or —CONR″—, —SO₂NR″—, —SO₂CH₂CH₂NR″—, —SO₂CH₂CH₂O—, or —SO₂CH₂CH₂S—, wherein R″ is H or a C₁-C₆ alkyl group.

In addition, the at least one organic group may comprise at least one group having the formula —CR═C(PO₃H₂)₂, partial esters thereof, and salts thereof. R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In one embodiment, R is H, a C₁-C₆ alkyl group, or an aryl group.

In one embodiment, the at least one organic group may comprise more than two phosphonic acid groups, partial esters thereof, and salts thereof and may, for example comprise more than one type of group (such as two or more) in which each type of group comprises at least two phosphonic acid groups, partial esters thereof, and salts thereof. For example, the at least one organic group may comprise a group having the formula —Y—[CQ(PO₃H₂)₂]ₚ, partial esters thereof, or salt thereof. Y and Q are as described above. In one embodiment, Y is an arylene, heteroarylene, alkylene, alkarylene, or aralkylene group. In this formula, p is 1 to 4, e.g., p is 2.

In one embodiment, the at least one organic group may comprise at least one vicinal bisphosphonic acid group, partial ester thereof, and salts thereof, meaning that these groups are adjacent to each other. Thus, the at least one organic group may comprise two phosphonic acid groups, partial esters thereof, and salts thereof bonded to adjacent or neighboring carbon atoms. Such groups are also sometimes referred to as 1,2-diphosphonic acid groups, partial esters thereof, and salts thereof. The group comprising the two phosphonic acid groups, partial esters thereof, and salts thereof may be an aromatic group or an alkyl group, and therefore the vicinal bisphosphonic acid group may be a vicinal alkyl or a vicinal aryl diphosphonic acid group, partial ester thereof, and salts thereof. For example, the at least one organic group may be a group having the formula —C₆H₃—(PO₃H₂)₂, partial esters thereof, and salts thereof, wherein the acid, ester, or salt groups are in positions ortho to each other.

In one embodiment, the at least one organic group comprises at least one phosphonic acid group or a salt thereof and at least one second ionic, ionizable, or basic group vicinal or geminal to the phosphonic acid group, and salts thereof.

In one embodiment, the at least one organic group is selected from —C(OH)(PO₃H₂)₂, —CH₂C(OH)(PO₃H₂)₂, —CH₂CH₂C(OH)(PO₃H₂)₂, —CH₂CH₂CH₂C(OH)(PO₃H₂)₂, —CH(PO₃H₂)₂, —CH₂CH(PO₃H₂)₂, partial esters thereof, and salts thereof.

The amount of attached organic groups can be varied, depending on the desired use of the modified carbon black and the type of attached group. For example, the total amount of organic group may be from about 0.01 to about 10.0 micromoles of groups/m² surface area of pigment, as measured by nitrogen adsorption (BET method), including from about 0.5 to about 5.0 micromoles/m², from about 1 to about 3 micromoles/m², or from about 2 to about 2.5 micromoles/m². Additional attached organic groups, which differ from those described for the various embodiments of the present invention, may also be present.

The unmodified pigment, prior to attachment, can be any type of pigment conventionally used by those skilled in the art, such as black pigments and other colored pigments including blue, black, brown, cyan, green, white, violet, magenta, red, orange, or yellow pigments. Mixtures of different pigments can also be used. Representative examples of black pigments include various carbon blacks (Pigment Black 7) such as channel blacks, furnace blacks, gas blacks, and lamp blacks, and include, for example, carbon blacks sold as Regal®, Black Pearls®, Elftex®, Monarch®, Mogul®, and Vulcan® carbon blacks available from Cabot Corporation (such as Black Pearls® 2000, Black Pearls® 1400, Black Pearls® 1300, Black Pearls®1100, Black Pearls®1000, Black Pearls® 900, Black Pearls® 880, Black Pearls®800, Black Pearls®700, Black Pearls® 570, Black Pearls® L, Elftex® 8, Monarch® 1400, Monarch® 1300, Monarch® 1100, Monarch® 1000, Monarch® 900, Monarch® 880, Monarch® 800, Monarch® 700, Regal®660, Mogul® L, Regal® 330, Regal® 400, Vulcan® P). Carbon blacks available from other suppliers can be used. Suitable classes of colored pigments include, for example, anthraquinones, phthalocyanine blues, phthalocyanine greens, diazos, monoazos, pyranthrones, perylenes, heterocyclic yellows, quinacridones, quinolonoquinolones, and (thio)indigoids. Such pigments are commercially available in either powder or press cake form from a number of sources including, BASF Corporation, Engelhard Corporation, Sun Chemical Corporation, Clariant, and Dianippon Ink and Chemicals (DIC). Examples of other suitable colored pigments are described in the Colour Index, 3rd edition (The Society of Dyers and Colourists, 1982). In one embodiment, the pigment is a cyan pigment, such as Pigment Blue 15, Pigment Blue 15:3, Pigment Blue 15:4, or Pigment Blue 60, a magenta pigment, such as Pigment Red 122, Pigment Red 177, Pigment Red 185, Pigment Red 202, or Pigment Violet 19, a yellow pigment, such as Pigment Yellow 74, Pigment Yellow 128, Pigment Yellow 139, Pigment Yellow 155, Pigment Yellow 180, Pigment Yellow 185, Pigment Yellow 218, Pigment Yellow 220, or Pigment Yellow 221, an orange pigment, such as Pigment Orange 168, a green pigment, such as Pigment Green 7 or Pigment Green 36, or black pigment, such as carbon black.

In one embodiment, the pigment can be present in an amount effective to provide the desired image quality (for example, optical density) without detrimentally affecting the performance of the inkjet ink. In one embodiment, the pigment is present in the inkjet ink composition in an amount ranging from 0.1% to 20%, e.g., from 1% to 20%, from 1% to 10%, or from 3% to 8%, based on the total weight of the inkjet ink composition.

### Dispersions and Inkjet Ink Compositions

In one embodiment, the dispersion is an aqueous dispersion such as an inkjet ink composition, e.g., comprising an aqueous liquid medium, which can be water. In one embodiment, the dispersion or inkjet ink composition comprises at least 40% water, e.g., at least 45% water or at least 50% water.

In one embodiment, the dispersion or inkjet ink composition comprises at least one organic solvent present in an amount ranging from 1% to 50% relative to the total weight of the inkjet ink composition, or present in other amounts as disclosed herein. In one embodiment, the organic solvent is soluble or miscible in water. In another embodiment, the organic solvent is chemically stable to aqueous hydrolysis conditions (e.g., reaction with water under heat aging conditions, including, for example, the hydrolysis of esters and lactones). In one embodiment, the organic solvent has a dielectric constant below that of water, such as a dielectric constant ranging from about 10 to about 78 at 20° C. Examples of suitable organic solvents include low molecular-weight glycols (such as ethylene glycol, diethylene glycol, triethylene glycol, tetraethylene glycol, dipropylene glycol, ethylene glycol monomethyl ether, ethylene glycol monoethyl ether, triethylene glycol monomethyl or monoethyl ether, diethylene glycol monomethyl ether, diethylene glycol monoethyl ether, diethylene glycol monobutyl ether, and tetraethylene glycol monobutyl ether); alcohols (such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol); diols containing from about 2 to about 40 carbon atoms (such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, and poly(ethylene-co-propylene) glycol, as well as their reaction products with alkylene oxides, including ethylene oxides, including ethylene oxide and propylene oxide); triols containing from about 3 to about 40 carbon atoms (such as glycerine (glycerol), trimethylolethane, trimethylolpropane, 1,3,5-pentanetriol, 1,2,6-hexanetriol, and the like as well as their reaction products with alkylene oxides, including ethylene oxide, propylene oxide, and mixtures thereof); polyols (such as pentaerythritol); amides (such as dimethyl formaldehyde and dimethyl acetamide); ketones or ketoalcohols (such as acetone and diacetone alcohol); ethers (such as tetrahydrofuran and dioxane); lactams (such as 2-pyrrolidone, N-methyl-2-pyrrolidone, and ε-caprolactam); ureas or urea derivatives (such as di-(2-hydroxyethyl)-5,5,-dimethyl hydantoin (dantacol) and 1,3-dimethyl-2-imidazolidinone); inner salts (such as betaine); and hydroxyamide derivatives (such as acetylethanolamine, acetylpropanolamine, propylcarboxyethanolamine, and propylcarboxy propanolamine, as well as their reaction products with alkylene oxides). Additional examples include saccharides (such as maltitol, sorbitol, gluconolactone and maltose); sulfoxide derivatives (symmetric and asymmetric) containing from about 2 to about 40 carbon atoms (such as dimethylsulfoxide, methylethylsulfoxide, and alkylphenyl sulfoxides); and sulfone derivatives (symmetric and asymmetric) containing from about 2 to about 40 carbon atoms (such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, and dimethylsulfolane). The organic solvent can comprise mixtures of organic solvents.

The amount of the solvent can be varied depending on a variety of factors, including the properties of the solvent (solubility and/or dielectric constant), the type of colorant, and the desired performance of the resulting inkjet ink composition. The solvent may be used in amounts ranging from 1% to 40% by weight based on the total weight of the inkjet ink composition, including amounts ranging from 1% to 30%, or amounts ranging from 1% to 20%. In another embodiment, the amount of the solvent is greater than or equal to about 2% by weight based on the total weight of the aqueous dispersion or inkjet ink composition, including greater than or equal to about 5% and greater than or equal to about 10% by weight.

In one embodiment, an ink composition (e.g., an inkjet ink composition) comprises at least one surfactant, e.g., when the pigment is not self-dispersible. The at least one surfactant can enhance the colloidal stability of the composition or change the interaction of the ink with either the printing substrate, such as printing paper, or with the ink printhead. Various anionic, cationic and nonionic surfactants can be used in conjunction with the ink composition of the present invention, and these may be used neat or as a water solution. In one embodiment, the surfactant is present in an amount ranging from 0.05% to 5%, e.g., an amount ranging from 0.1% to 5%, or from 0.5% to 2%, by weight relative to the total weight of the inkjet ink composition.

Representative examples of anionic surfactants include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthanates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates and alkyl phosphates, alkyl phosphonates and bisphosphonates, included hydroxylated or aminated derivatives. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Representative examples of cationic surfactants include aliphatic amines, quaternary ammonium salts, sulfonium salts, phosphonium salts and the like.

Representative examples of nonionic surfactants that can be used in ink jet inks of the present invention include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols, polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used. These nonionic surfactants or dispersants can be used alone or in combination with the aforementioned anionic and cationic dispersants.

In one embodiment, the inkjet ink further comprises at least one water-soluble compound having a hydroxyl number of at least 80, wherein the at least one water-soluble compound is selected from ethoxylated C₃-C₂₀ polyols, such as ethoxylated triols, ethoxylated tetraols, ethoxylated pentaols, and ethoxylated hexaols. In one embodiment, the ethoxylated C₃-C₂₀ polyols are selected from ethoxylated glycerol, ethoxylated pentaerythritol, ethoxylated trimethylolpropane, ethoxylated glucoside, and ethoxylated glucose. In another embodiment, the at least one water-soluble compound is selected from polyols having three or more hydroxyl groups (e.g., xylitol and sorbitol), and polyether polyols. The at least one water-soluble compound can be present in an amount ranging from 1% to by 60% weight, relative to the total weight of the inkjet ink composition.

In one embodiment, the inkjet ink composition has a viscosity ranging from 1-25 cP. It is understood that viscosity can be adjusted by a variety of methods. Exemplary rheological additives to adjust the viscosity of an inkjet ink composition include, but are not limited to, alkali swellable emulsions (such as Rheovis® AS rheology-control additive from BASF), hydrophobically modified alkali swellable emulsions (such as Rheovis® HS rheology-control additive from BASF), hydrophobically modified polyurethanes (such as Rheovis® PU rheology-control additive from BASF), and hydrophobically modified polyethers (such as Rheovis® PE rheology-control additive from BASF).

In one embodiment, the inkjet ink compositions may further comprise dyes to modify color balance and adjust optical density. Exemplary dyes include food dyes, FD&C dyes, acid dyes, direct dyes, reactive dyes, derivatives of phthalocyanine sulfonic acids, including copper phthalocyanine derivatives, sodium salts, ammonium salts, potassium salts, and lithium salts.

In one embodiment, the inkjet ink compositions can further comprise one or more suitable additives to impart a number of desired properties while maintaining the stability of the compositions. Other additives are well known in the art and include humectants, biocides and fungicides, pH control agents, drying accelerators, penetrants, and the like. The amount of a particular additive will vary depending on a variety of factors but are generally present in an amount ranging between 0.01% and 40% based on the weight of the inkjet ink composition. In one embodiment, the at least one additive is present in an amount ranging from 0.05% to 5%, e.g., an amount ranging from 0.1% to 5%, or an amount ranging from 0.5% to 2%, by weight relative to the total weight of the inkjet ink composition

Humectants and water soluble organic compounds other than the at least one organic solvent may also be added to the inkjet ink composition of the present invention, e.g., for the purpose of preventing clogging of the nozzle as well as for providing paper penetration (penetrants), improved drying (drying accelerators), and anti-cockling properties. In one embodiment, the humectant and/or water soluble compound is present in an amount ranging from 0.1% to 50%, e.g., an amount ranging from 1% to 50%, from 0.1% to 30%, from 1% to 30%, from 0.1% to 10%, or from 1% to 10%.

Specific examples of humectants and other water soluble compounds that may be used include low molecular-weight glycols such as ethylene glycol, diethylene glycol, triethylene glycol, tetraethylene glycol and dipropylene glycol; diols containing from about 2 to about 40 carbon atoms, such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, poly(ethylene-co-propylene) glycol, and the like, as well as their reaction products with alkylene oxides, including ethylene oxides, including ethylene oxide and propylene oxide; triol derivatives containing from about 3 to about 40 carbon atoms, including glycerine, trimethylolpropane, 1,3,5-pentanetriol, 1,2,6-hexanetriol, and the like as well as their reaction products with alkylene oxides, including ethylene oxide, propylene oxide, and mixtures thereof; neopentylglycol, (2,2-dimethyl-1,3-propanediol), and the like, as well as their reaction products with alkylene oxides, including ethylene oxide and propylene oxide in any desirable molar ratio to form materials with a wide range of molecular weights; thiodiglycol; pentaerythritol and lower alcohols such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol; amides such as dimethyl formaldehyde and dimethyl acetamide; ketones or ketoalcohols such as acetone and diacetone alcohol; ethers such as tetrahydrofuran and dioxane; cellosolves such as ethylene glycol monomethyl ether and ethylene glycol monoethyl ether, triethylene glycol monomethyl (or monoethyl) ether; carbitols such as diethylene glycol monomethyl ether, diethylene glycol monoethyl ether, and diethylene glycol monobutyl ether; lactams such as 2-pyrrolidone, N-methyl-2-pyrrolidone and ε-caprolactam; urea and urea derivatives; inner salts such as betaine, and the like; thio (sulfur) derivatives of the aforementioned materials including 1-butanethiol; t-butanethiol 1-methyl-1-propanethiol, 2-methyl-1-propanethiol; 2-methyl-2-propanethiol; thiocyclopropanol, thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy propanolamine, and the like; reaction products of the aforementioned materials with alkylene oxides; and mixtures thereof. Additional examples include saccharides such as maltitol, sorbitol, gluconolactone and maltose; polyhydric alcohols such as trimethylol propane and trimethylol ethane; N-methyl-2-pyrrolidone; 1,3-dimethyl-2-imidazolidinone; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; and sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like. Such materials may be used alone or in combination.

Biocides and/or fungicides may also be added to the aqueous dispersions or inkjet ink composition disclosed herein. Biocides are important in preventing bacterial growth since bacteria are often larger than ink nozzles and can cause clogging as well as other printing problems. Examples of useful biocides include, but are not limited to, benzoate or sorbate salts, and isothiazolinones. In one embodiment, the biocides and/or fungicides are present in an amount ranging from 0.05% to 5% by weight, 0.05% to 2% by weight, 0.1% to 5% by weight, or 0.1% to 2% by weight, relative to the total weight of the composition.

### EXAMPLES

A series of inks were prepared to demonstrate the improvement in O.D. of inks containing the acrylic polymers disclosed herein. Table 1 below lists the ink formulation used for the examples and comparative examples.

TABLE 1

| | |
|---|---|
| Pigment | 5% |
| Glycerol | 10% |
| 2-pyrrolidinone | 4% |
| 1,2-hexanediol | 6% |
| S465* | 1% |
| polymer additive | 1% |
| Water | balance |

*S465 = Surfynol ® 465 surfactant, an ethoxylated acetylenic diol (Air Products)

The polymeric additives used for the examples and comparative examples are listed below:
Joncryl® resins—styrene acrylic polymers from BASF neutralized by sodium hydroxide or used as is if already predissolved in base; Joncryl® resins 50, 684, 680, 675, 693, 60, 7025, 96, 71, 586 are used (abbreviated as J50, J684, J680, J675, J693, J60, J7025, J96, 171, J586);
SMA® resins—styrene/maleic anhydride polymers from Cray Valley; SMA® resins 1440, 2000, 3000, EF40, and EF60 are used after hydrolysis with NaOH (abbreviated as SMA 1440, SMA 2000, SMA 3000, SMA EF40, and SMA EF60);
Pluronic® F38 surfactant—a triblock copolymer based on polyethylene oxide/polypropylene oxide (PEO/PPO) from BASF (abbreviated as Plur. F38);
PVP10K—a polyvinylpyrrolidone having an average molecular weight of 10,000, from Sigma Aldrich;
PEG 1000—a polyethylene glycol having an average molecular weight of 1000, from Sigma Aldrich; and
AQ55S or AQ™ 55S polymer—a sulfonated polyester from Eastman Chemical.

A control ink was also prepared according to the formulation of Table 1 but without polymer additive.

In the examples and comparative examples, inks made with various polymer additives were evaluated on two plain papers without inkjet treatment: Xerox 4200 (Xerox) and Staples copy paper (Staples) and an inkjet treated paper from HP: HP multipurpose ultra white (HPMP).

Drawdowns of inks (70 μL) were obtained with a #3 wire-wound lab rod on each of the Staples, Xerox and HPMP papers. The optical density (OD) was obtained by using an X-rite 530 spectrophotometer with the following settings: Illumination at D65, 2 degree Standard Observer, DIN density standard, white base set to Abs, and no filter. For each paper, the OD value was reported as an average of at least 3 measurements taken at the top, medium and bottom of the drawdown images.

The control ink was evaluated on HPMP paper for OD variability. Table 2 lists the variability of OD measurements on drawdowns.

TABLE 2

| Control ink | HPMP |
|---|---|
| OD1 | 1.42 |
| OD2 | 1.45 |
| OD3 | 1.42 |
| OD4 | 1.46 |
| OD5 | 1.43 |
| standard deviation (σ) | 0.018 |
| 3σ | 0.05 |

For the control ink, the standard deviation (σ) was 0.02. Accordingly, a threshold OD difference was determined to be an increase or decrease of greater than or equal to 3σ, i.e., greater than or equal to 0.05.

### Examples 1-7 and Comparative Examples 1-13

From the formulation of Table 1, Examples 1-7 were prepared with various acrylic resins. Comparative Examples 1-13 were prepared with either non-acrylic resins or with acrylic resins having a molecular weight greater than 15,000 and/or an acid number less than 150. For each of Examples 1-7, Comparative Examples 1-13, and the control sample, the pigment used was carbon black modified with bisphosphonate groups, prepared as described in Example 72 of U.S. Pat. No. 8,858,695, the disclosure of which is incorporated herein by reference, which has a calcium index value of 3.45.

Table 3 provides the polymer additives and their properties for each of Examples 1-7 and Comparative Examples 1-13, as well as the corresponding OD data on non-inkjet treated (plain) papers (Xerox and Staples) and inkjet treated paper (HPMP). The Δ OD value=OD (sample)−OD(control).

TABLE 3

| | | Polymer | | | OD | OD | OD | Δ OD | Δ OD | Δ OD | |
|---|---|---|---|---|---|---|---|---|---|---|---|
| Ink | Polymer | type | Mw | AN | HPMP | Xerox | Staples | HPMP | Xerox | Staples | Rating |
| control | none | — | — | — | 1.43 | 1.04 | 1.12 | 0 | 0 | 0 | |
| Ex 1 | J50 | acrylic | 1700 | 238 | 1.4 | 1.12 | 1.19 | −0.03 | 0.08 | 0.07 | A |
| Ex 2 | J684 | acrylic | 1800 | 244 | 1.39 | 1.14 | 1.19 | −0.04 | 0.1 | 0.07 | A |
| Ex 3 | J680 | acrylic | 4900 | 215 | 1.39 | 1.11 | 1.19 | −0.04 | 0.07 | 0.07 | A |
| Ex 4 | J675 | acrylic | 5700 | 222 | 1.39 | 1.1 | 1.19 | −0.04 | 0.06 | 0.07 | A |
| Ex 5 | J693 | acrylic | 6000 | 205 | 1.4 | 1.1 | 1.18 | −0.03 | 0.06 | 0.06 | A |
| Ex 6 | J60 | acrylic | 8600 | 215 | 1.4 | 1.13 | 1.22 | −0.03 | 0.09 | 0.1 | A |
| Ex 7 | J7025 | acrylic | 12500 | 235 | 1.41 | 1.15 | 1.21 | −0.02 | 0.11 | 0.09 | A |
| Ex 8 | J683 | acrylic | 8000 | 165 | 1.42 | 1.1 | 1.19 | −0.01 | 0.06 | 0.07 | A |
| Comp 1 | J96 | acrylics | 16000 | 220 | 1.31 | 1.13 | 1.18 | −0.12 | 0.09 | 0.06 | B |
| Comp 2 | J71 | acrylic | 17250 | 214 | 1.35 | 1.11 | 1.19 | −0.08 | 0.07 | 0.07 | B |
| Comp 3 | J586 | acrylic | 4600 | 108 | 1.43 | 1.08 | 1.16 | 0 | 0.04 | 0.04 | C |
| Comp 4 | J201 | acrylic | 16000 | 125 | 1.43 | 1.08 | 1.17 | 0 | 0.04 | 0.05 | C |
| Comp 5 | SMA1440 | SMA | 7000 | 185 | 1.35 | 1.09 | 1.18 | −0.08 | 0.05 | 0.06 | C |
| Comp 6 | SMA2000 | SMA | 7500 | 355 | 1.33 | 1.09 | 1.15 | −0.1 | 0.05 | 0.03 | C |
| Comp 7 | SMA3000 | SMA | 9500 | 280 | 1.31 | 1.1 | 1.17 | −0.12 | 0.06 | 0.05 | B |
| Comp 8 | SMA EF40 | SMA | 11000 | 215 | 1.36 | 1.07 | 1.14 | −0.07 | 0.03 | 0.02 | C |
| Comp 9 | SMA EF60 | SMA | 11500 | 156 | 1.35 | 1.07 | 1.16 | −0.08 | 0.03 | 0.04 | C |
| Comp 10 | Plur. F38 | PEO/PPO | 4700 | 0 | 1.45 | 1.07 | 1.15 | 0.02 | 0.03 | 0.03 | C |
| Comp 11 | PEG1000 | PEG | 1000 | 0 | 1.44 | 1.06 | 1.16 | 0.01 | 0.02 | 0.04 | C |
| Comp 12 | PVP10K | PVP | 10000 | 0 | 1.43 | 1.07 | 1.13 | 0 | 0.03 | 0.01 | C |
| Comp 13 | AQ55S | polyester | 20000 | 37 | 1.35 | 1.05 | 1.12 | −0.08 | 0.01 | 0 | C |

The “Rating” is determined according to the parameters of Table 4.

TABLE 4

| | |
|---|---|
| A | Δ OD ≥ 0.05 on both plain papers and Δ OD ≥ −0.05 on treated |
| | paper |
| B | Δ OD ≥ 0.05 on both plain papers and Δ OD < −0.05 on treated |
| | paper |
| C | Δ OD < 0.05 on at least one plain paper |

From the data of Table 3, it can be seen that acrylic polymers according to the claimed invention afforded better OD on the two plain papers and little change on the inkjet-treated paper. Inks comprising polymers having a low acid number do not display any O.D. improvement. Inks comprising polymers having a high molecular weight show decreased O.D. performance on the treated paper.

### Comparative Examples 14-29

The inks of Comparative Examples 14-29 were prepared according to Table 1 where the carbon black is modified with groups having a calcium index of less than or equal to that of 1,2,3-benzene tricarboxylic acid. Specifically, the pigments are modified with the following functional groups: toluene sulfonic acid (Comparative Examples 14-17); benzoic acid (Comparative Examples 18-21); isophthalic acid (Comparative Examples 22-25); and 1,2,3-benzene tricarboxylic acid (Comparative Examples 26-29), each of which was prepared according to the method of U.S. Pat. No. 5,571,311, the disclosure of which is incorporated herein by reference. Table 5 lists the polymer additives and OD data.

TABLE 5

| | | OD | OD | OD | Δ OD | Δ OD | Δ OD | |
|---|---|---|---|---|---|---|---|---|
| | Polymer | HPMP | Xerox | Staples | HPMP | Xerox | Staples | Rating |
| Comp 14 | — | 1.12 | 0.97 | 0.99 | 0 | 0 | 0 | |
| Comp 15 | J50 | 1.11 | 0.98 | 1.01 | 0 | 0.01 | 0.02 | C |
| Comp 16 | J586 | 1.16 | 0.99 | 1.01 | 0.04 | 0.02 | 0.02 | C |
| Comp 17 | SMA EF40 | 1.16 | 0.99 | 1.01 | 0.04 | 0.02 | 0.01 | C |
| Comp 18 | — | 1.22 | 1 | 1.01 | 0 | 0 | 0 | |
| Comp 19 | J50 | 1.2 | 1 | 1.01 | −0.01 | −0.01 | 0 | C |
| Comp 20 | J586 | 1.24 | 1.01 | 1.02 | 0.03 | 0 | 0.01 | C |
| Comp 21 | SMA EF40 | 1.22 | 1 | 1.01 | 0 | 0 | 0.01 | C |
| Comp 22 | — | 1.22 | 1 | 1 | 0 | 0 | 0 | |
| Comp 23 | Joncryl 50 | 1.2 | 1.03 | 1.04 | −0.02 | 0.03 | 0.04 | C |
| Comp 24 | Joncryl 586 | 1.22 | 1.02 | 1.03 | 0 | 0.01 | 0.03 | C |
| Comp 25 | SMA EF 40 | 1.21 | 1.02 | 1.03 | −0.01 | 0.02 | 0.03 | C |
| Comp 26 | — | 1.22 | 1 | 1.01 | 0 | 0 | 0 | |
| Comp 27 | Joncryl 50 | 1.2 | 1 | 1.01 | −0.01 | −0.01 | 0 | C |
| Comp 28 | Joncryl 586 | 1.24 | 1.01 | 1.02 | 0.03 | 0 | 0.01 | C |
| Comp 29 | SMA EF 40 | 1.22 | 1 | 1.01 | 0 | 0 | 0.01 | C |

Unlike the examples listed in Table 3, the data of Table 5 indicates that little or no OD effect is seen using these carbon black dispersions with various polymer additives, even polymer additives according to the claimed invention. It can be seen that the combination of the claimed polymer and pigment achieves the desired OD effect.

### Example 9 and Comparative Examples 30-36

This set of samples demonstrate the OD response of pigment red 122 (PR122) treated with functional groups having different calcium binding indices in the presence of polymer additives. Specifically, the pigments are modified with the following functional groups: toluene sulfonic acid (Comparative Examples 30-33), prepared according to the method of U.S. Pat. No. 5,571,311, the disclosure of which is incorporated herein by reference; and bisphosphonic acid (Example 9 and Comparative Examples 34-36), prepared as described in Example 72 of U.S. Pat. No. 8,858,695, the disclosure of which is incorporated herein by reference. Table 6 lists the polymer additives and OD data.

TABLE 6

| | | | | OD | OD | OD | Δ OD | Δ OD | Δ OD | |
|---|---|---|---|---|---|---|---|---|---|---|
| | Polymer | Mw | AN | HPMP | Xerox | Staples | HPMP | Xerox | Staples | Rating |
| Comp 30 | — | — | — | 0.94 | 0.85 | 0.87 | 0 | 0 | 0 | |
| Comp 31 | J60 | 8600 | 215 | 0.95 | 0.85 | 0.85 | 0.01 | 0 | −0.01 | C |
| Comp 32 | J586 | 4600 | 108 | 1.01 | 0.86 | 0.87 | 0.07 | 0 | 0 | C |
| Comp 33 | SMA EF40 | 11000 | 215 | 1.01 | 0.86 | 0.87 | 0.07 | 0 | 0 | C |
| Comp 34 | — | — | — | 1.15 | 0.84 | 0.86 | 0 | 0 | 0 | |
| Ex 9 | J60 | 8600 | 215 | 1.14 | 0.89 | 0.93 | −0.01 | 0.05 | 0.07 | A |
| Comp 35 | J586 | 4600 | 108 | 1.1 | 0.85 | 0.89 | −0.05 | 0.01 | 0.03 | C |
| Comp 36 | SMA EF40 | 11000 | 215 | 1.07 | 0.85 | 0.89 | −0.08 | 0.02 | 0.03 | C |

From the data of Table 5 with PR122 as the base pigment, the OD response shows a similar trend to the carbon black examples. Only in Example 9, where PR122 was surface treated with a functional group having a with higher calcium binding index, an OD increase on the two plain papers is observed in the presence of a low molecular weight and high acid number polymer.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. An inkjet ink composition comprising:
at least one pigment having attached at least one organic group having a calcium index value greater than a calcium index value of 1,2,3-benzene tricarboxylic acid;
at least one acrylic polymer having an acid number of at least 150 and a weight average molecular weight ranging from 1,000 to 15,000; and
an aqueous liquid medium.

2. The composition of claim 1, wherein the acid number ranges from 150 to 400.

3. The composition of claim 1, wherein the acid number is at least 160.

4. The composition of claim 1, wherein the molecular weight ranges from 1,000 to 13,000.

5. The composition of claim 1, wherein the at least one acrylic polymer is self-dispersible or soluble in the aqueous liquid medium.

6. The composition of claim 1, wherein the at least one acrylic polymer is a salt of at least one of an alkali metal and an organic amine.

7. The composition of claim 1, wherein the at least one acrylic polymer is a copolymer.

8. The composition of claim 1, wherein the at least one acrylic polymer comprises at least one acrylic monomer in an amount of at least 20 mol %.

9. The composition of claim 1, wherein the at least one acrylic polymer comprises at least one acrylic monomer in an amount ranging from 20 mol % to 75 mol %.

10. The composition of claim 8, wherein the at least one acrylic monomer is selected from acrylic acid, methacrylic acid, crotonic acid, ethacrylic acid, propylacrylic acid, isopropylacrylic acid, itaconic acid, fumaric acid, and salts thereof.

11. The composition of claim 8, wherein the at least one acrylic monomer is selected from acrylic acid and methacrylic acid.

12. The composition of claim 8, further comprising at least one second monomer selected from: esters, aminoesters and amides of acrylic acid, methacrylic acid, crotonic acid, ethacrylic acid, propylacrylic acid, isopropylacrylic acid, itaconic acid, fumaric acid, and maleic acid; addition reaction products between oil and fatty acids and (meth)acrylic ester monomers having an oxirane structure; addition reaction products between oxirane compounds containing an alkyl group having 3 or more carbon atoms and (meth)acrylic acid; styrenes; acrylonitriles; acetates; and allyl alcohols.

13. The composition of claim 1, wherein the at least one organic group comprises at least two phosphonic acid groups, esters thereof, or salts thereof.

14. The composition of claim 1, wherein the at least one organic group comprises at least one geminal bisphosphonic acid group, esters thereof, or salts thereof.

15. The composition of claim 1, wherein the at least one organic group comprises at least one group having the formula —CQ(PO₃H₂)₂ or salts thereof, wherein Q is H, R, OR, SR, or NR₂ wherein R, which can be the same or different, is selected from H, C₁-C₁₈ alkyl, C₁-C₁₈ acyl, aralkyl, alkaryl, and aryl.

16. The composition of claim 1, wherein the at least one organic group comprises at least one group having the formula —(CH₂)n-CQ(PO₃H₂)₂ or salts thereof, wherein n is an integer ranging from 1 to 9.

17. The composition of claim 1, wherein the at least one organic group comprises at least one group having the formula —CR═C(PO₃H₂)₂ or salts thereof, and wherein R is selected from H, C₁-C₆ alkyl, aryl.

18. The composition of claim 1, wherein the at least one organic group comprises at least one phosphonic acid group or a salt thereof, and at least one second ionic, ionizable, or basic group vicinal or geminal to the at least one phosphonic acid group or salt thereof.

19. The composition of claim 1, wherein the aqueous liquid medium is water.
